(19) United States
(12) Patent Application Publication
(10) Pub. No.: US 2026/0323126 A1
(43) Pub. Date: Oct. 15, 2026

(54) INFORMATION PRESENTATION METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Yongwen LIU, Shenzhen (CN); Ziyue ZHENG, Shenzhen (CN); Haoran DING, Shenzhen (CN); Shuyuan LI, Shenzhen (CN); Peiyao CHENG, Shenzhen (CN)

(21) Appl. No.: 19/691,227

(22) Filed: May 28, 2026

Related U.S. Application Data
(63) Continuation of application No. PCT/CN2025/077788, filed on Feb. 18, 2025.

(30) Foreign Application Priority Data
Feb. 29, 2024 (CN) 202410235851.8

(51) Int. Cl. H04N 21/472; H04N 21/431

(52) U.S. Cl. CPC H04N 21/47217; H04N 21/4318

(57) ABSTRACT

An information presentation method includes: displaying a video played at a first playback speed on a video playback interface; playing the video at a second playback speed less than the first playback speed and displaying guide information in response to that a playback adjustment condition of the video is satisfied, the guide information providing guidance for performing a target interactive operation on the video playback interface; and playing the video at the first playback speed and displaying target content in response to that the target interactive operation is performed.

### CROSS-REFERENCES TO RELATED APPLICATIONS

This application is a continuation of PCT Application No. PCT/CN 2025/077788, filed on Feb. 18, 2025, which claims priority to Chinese Patent Application No. 202410235851.8 filed on Feb. 29, 2024, and claim priority to the Chinese Patent Application, the entire contents of all of which are incorporated herein by reference.

### FIELD OF THE TECHNOLOGY

The present disclosure relates to the field of Internet technologies, and in particular, to an information presentation method and apparatus, an electronic device, a computer-readable storage medium, and a computer program product.

### BACKGROUND OF THE DISCLOSURE

When an advertisement is delivered based on a video player, advertisement content is usually played at a fixed time point of a video, and another interactive operation cannot be performed with the advertisement content. Based on this, advertisement delivery manners for delivering an advertisement during video playback are relatively monotonous, and lack innovation and user interactivity, resulting in reduced human-computer interaction efficiency and reduced utilization of hardware processing resources.

### SUMMARY

Embodiments of the present disclosure provide an information presentation method and apparatus, an electronic device, a computer-readable storage medium, and a computer program product, to improve diversity of information presentation manners, human-computer interaction efficiency, and utilization of hardware processing resources during video playback.

Technical solutions in embodiments of the present disclosure are implemented as follows.

An embodiment of the present disclosure provides an information presentation method. The method is performed by an electronic device and includes: displaying a video played at a first playback speed on a video playback interface; playing the video at a second playback speed less than the first playback speed and displaying guide information in response to that a playback adjustment condition of the video is satisfied, the guide information providing guidance for performing a target interactive operation on the video playback interface; and playing the video at the first playback speed and displaying target content in response to that the target interactive operation is performed.

An embodiment of the present disclosure provides an information presentation apparatus. The apparatus includes: a first display module, configured to display a video played at a first playback speed on a video playback interface; a second display module, configured to: play the video at a second playback speed less than the first playback speed and display guide information in response to that a playback adjustment condition of the video is satisfied, the guide information providing guidance for performing a target interactive operation on the video playback interface; and a third display module, configured to: play the video at the first playback speed and display target content in response to that the target interactive operation is performed.

An embodiment of the present disclosure provides an electronic device. The electronic device includes: a memory, configured to store computer-executable instructions or a computer program; and a processor, configured to implement, when executing the computer-executable instructions or the computer program stored in the memory, the information presentation method provided in embodiments of the present disclosure.

An embodiment of the present disclosure provides a non-transitory computer-readable storage medium. The computer-readable storage medium includes computer-executable instructions or a computer program. A processor executes the computer-executable instructions or the computer program to implement the information presentation method provided in embodiments of the present disclosure.

An embodiment of the present disclosure provides a computer program product or a computer program. The computer program product includes computer-executable instructions or the computer program. A processor executes the computer-executable instructions or the computer program, so that an electronic device performs the information presentation method provided in embodiments of the present disclosure.

Embodiments of the present disclosure have the following beneficial effects.

First, in a process of playing the video at the first playback speed, when the playback adjustment condition of the video is satisfied, a playback speed of the video is switched to the second playback speed less than the first playback speed, and the guide information for guiding to perform the target interactive operation on currently-played video content is displayed. Therefore, based on the guide information, in response to that the target interactive operation is performed, the playback speed of the video is restored to the first playback speed, and the target content is displayed. In this way, the video is played based on the target interactive operation performed by a user on the currently-played video content, and the target content is displayed, thereby not only improving interaction engagement of the user and a sense of participation of the user on the currently-played video content, but also improving diversity of information presentation manners during video playback, and improving human-computer interaction efficiency and utilization of hardware resources of the electronic device.

### BRIEF DESCRIPTION OF THE DRAWINGS

FIG. 1 is a schematic diagram of an architecture of an information presentation system according to an embodiment of the present disclosure.

FIG. 2 is a schematic diagram of a structure of an electronic device according to an embodiment of the present disclosure.

FIG. 3 is a schematic flowchart of an information presentation method according to an embodiment of the present disclosure.

FIG. 4 is a schematic diagram of pausing playback of a video according to an embodiment of the present disclosure.

FIG. 5 is a schematic diagram of guide information according to an embodiment of the present disclosure.

FIG. 6 is a schematic diagram of playing a video clip associated with video content of a video through a floating window according to an embodiment of the present disclosure.

FIG. 7 is a schematic diagram of a current sliding trajectory according to an embodiment of the present disclosure.

FIG. 8 is a schematic diagram of an atmosphere element according to an embodiment of the present disclosure.

FIG. 9 is a schematic diagram of an atmosphere element according to an embodiment of the present disclosure.

FIG. 10 is a schematic diagram of a process of a method for pausing video playback, resuming playback through interaction, and presenting an advertisement based on user interaction according to an embodiment of the present disclosure.

### DESCRIPTION OF EMBODIMENTS

To make the objectives, technical solutions, and advantages of the present disclosure clearer, the following further describes embodiments of the present disclosure in detail with reference to the accompanying drawings. The described embodiments are not to be considered as a limitation to embodiments of the present disclosure. All other embodiments obtained by a person of ordinary skill in the art without creative efforts shall fall within the protection scope of the present disclosure.

In the following descriptions, the term “some embodiments” describes subsets of all possible embodiments, but “some embodiments” may be the same subset or different subsets of all the possible embodiments, and can be combined with each other without conflict.

In the following descriptions, the terms “first”, “second”, and “third” are merely intended to distinguish between similar objects rather than describe specific orders. The terms “first”, “second”, and “third” may, where permitted, be interchangeable in a particular order or sequence, so that embodiments of the present disclosure described herein may be performed in an order other than that illustrated or described herein.

Unless otherwise defined, meanings of all technical and scientific terms used in this specification are the same as those usually understood by a person skilled in the art to which the present disclosure belongs. Terms used in the specification are merely intended to describe objectives of embodiments of the present disclosure, but are not intended to limit the present disclosure.

Before embodiments of the present disclosure are further described in detail, a description is made on terms involved in embodiments of the present disclosure, and the terms in embodiments of the present disclosure are applicable to the following explanations.

(1) A client, also referred to as a user side, is a program corresponding to a server that provides a local service for a user. In addition to some applications that can only run locally, the client is generally installed on an ordinary client machine and needs to cooperate with the server to run. In other words, the client requires a corresponding server and service program in a network to provide a corresponding service. In this way, a specific communication connection needs to be established between the client and a server side, to ensure normal operation of the application, such as an autonomous driving client (for example, a map navigation client).

(2) Artificial intelligence (AI) is a theory, a method, a technology, and an application system that use a digital computer or a machine controlled by the digital computer to simulate, extend, and expand human intelligence, perceive an environment, obtain knowledge, and use knowledge to obtain an optimal result. In other words, the artificial intelligence is a comprehensive technology in computer science and attempts to understand the essence of intelligence and produce a new intelligent machine that can react in a manner similar to human intelligence. The artificial intelligence is to study design principles and implementation methods of various intelligent machines, to enable the machine to have functions of perception, reasoning, and decision-making.

(3) “In response to” is configured for representing a condition or a status on which an executed operation depends, and when the dependent condition or status is satisfied, one or more executed operations may be in real time or may have a set delay. There is no limitation on a sequence in which operations are performed without particular description.

(4) An advertiser is an entity having an advertisement delivery requirement on an advertisement delivery platform.

(5) A text link is a conversion component in an information flow page advertisement, that is, a text hyperlink, and tapping the link may redirect to a specified page.

(6) Machine learning (ML) is a multi-field interdisciplinary that relates to a plurality of disciplines such as the probability theory, statistics, the approximation theory, convex analysis, and the algorithm complexity theory. The machine learning specializes in studying how a computer simulates or implements a human learning behavior to obtain new knowledge or skills, and reorganize an existing knowledge structure, so as to keep improving its performance.

When an advertisement is delivered during video playback, the following problems generally exist. First, the advertisement is usually played at a fixed time point of a video, and cannot be flexibly adjusted based on a plot change and an interaction situation of a user. This may affect watching experience of the user. Second, during a regular video playback, user engagement is low, and the user can only passively receive information. Third, abruptness and irrelevance of the advertisement may lead to user aversion, resulting in reduced effect of the advertisement. Fourth, satisfaction of a personalized requirement of the user is usually ignored.

Based on this, embodiments of the present disclosure provide an information presentation method and apparatus, an electronic device, a computer-readable storage medium, and a computer program product. First, an interaction element is introduced, so that a sense of participation of a user is improved, and the user pays more attention to video content and an advertisement element during participation. Second, advertisement attention and acceptance can be effectively improved by inserting an advertisement at a plot climax or a key node with reference to user interaction. Third, accurate personalized advertisement delivery can be implemented based on an interaction path and feedback of the user, thereby improving targeting and effect of the advertisement. Fourth, according to a method for pausing video playback, resuming playback through interaction, and presenting the advertisement based on user interaction, not only can watching experience of the user be improved, but the user also becomes more engaged and participatory in a watching process, to improve user satisfaction and a retention rate.

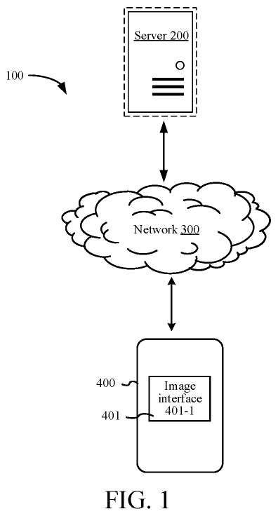

FIG. 1 is a schematic diagram of an architecture of an information presentation system according to an embodiment of the present disclosure. An information presentation client 401 is installed on a terminal (where a terminal 400 is shown as an example), and is displayed on a display interface (where an image interface 401-1 is shown as an example). The terminal 400 is connected to a server 200 through a network 300. The network 300 may be a wide area network or a local area network, or a combination of thereof. Data transmission may be implemented by using a wireless or wired link.

The server 200 is configured to send display data of a video playback interface to the terminal 400.

The terminal 400 is further configured to: receive the display data of the video playback interface sent by the server 200, and display a video played at a first playback speed on the video playback interface; play the video at a second playback speed less than the first playback speed and display guide information in response to that a playback adjustment condition of the video is satisfied, the guide information providing guidance for performing a target interactive operation on the video playback interface; and play the video at the first playback speed and display target content in response to that the target interactive operation is performed. The target content, as used herein, may also be referred to as target content.

In some embodiments, the server 200 may be an independent physical server, a server cluster or distributed system including a plurality of physical servers, or a cloud server providing basic cloud computing services, such as cloud services, cloud databases, cloud computing, cloud functions, cloud storage, network services, cloud communications, middleware services, domain name services, security services, content delivery networks (CDNs), and big data and artificial intelligence platforms. The terminal 400 may be a smartphone, a tablet computer, a notebook computer, a desktop computer, a set-top box, an intelligent voice interaction device, a smart home appliance, a virtual reality device, an on-board terminal, an aircraft, a portable music player, a personal digital assistant, a dedicated messaging device, a portable gaming device, a smart speaker, a smart watch, and the like, but is not limited thereto. The terminal and the server may be connected directly or indirectly in a wired or wireless communication manner, and this is not limited in embodiments of the present disclosure.

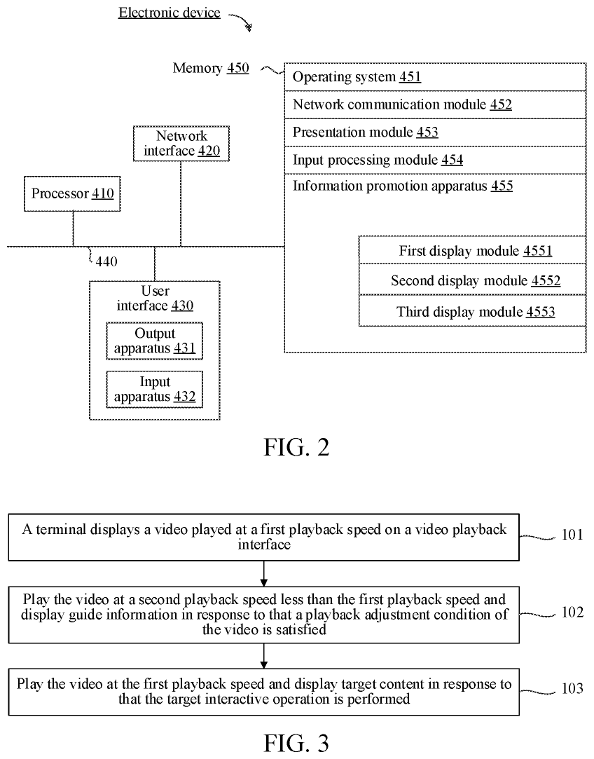

The following describes an electronic device that implements an information presentation method according to embodiments of the present disclosure. FIG. 2 is a schematic diagram of a structure of an electronic device according to an embodiment of the present disclosure. The electronic device may be a server or a terminal. An example in which the electronic device is the terminal shown in FIG. 1 is used, and the electronic device shown in FIG. 2 includes: at least one processor 410, a memory 450, at least one network interface 420, and a user interface 430. Components in the terminal 400 are coupled together through a bus system 440. The bus system 440 is configured to implement connection and communication between the components. In addition to a data bus, the bus system 440 further includes a power bus, a control bus, and a state signal bus. However, for ease of clear description, all buses in FIG. 3 are marked as the bus system 440.

The processor 410 may be an integrated circuit chip with a signal processing capability, like a general-purpose processor, a digital signal processor (DSP), or another programmable logic device, discrete gate, transistor logic device, discrete hardware component, or the like. The general-purpose processor may be a microprocessor, any processor, or the like.

The user interface 430 includes one or more output apparatuses 431 that can display media content, including one or more speakers and/or one or more visual display screens. The user interface 430 further includes one or more input apparatuses 432, including user interface components that facilitate user input, such as a keyboard, a mouse, a microphone, a touchscreen, a camera, and other input buttons and controls.

The memory 450 may be removable, irremovable, or a combination thereof. Exemplary hardware devices include a solid-state memory, a hard disk drive, an optical disk drive, and the like. The memory 450 in some embodiments includes one or more storage devices that are physically located away from the processor 410.

The memory 450 includes a volatile memory or a non-volatile memory, or may include both a volatile memory and a non-volatile memory. The non-volatile memory may be a read only memory (ROM), and the volatile memory may be a random access memory (RAM). The memory 450 described in this embodiment of the present disclosure is intended to include a memory of any suitable type.

In some embodiments, the memory 450 can store data to support various operations. Examples of the data include a program, a module, and a data structure, or a subset or a superset thereof, which are exemplarily described below.

An operating system 451 includes a system program configured to process various basic system services and perform hardware-related tasks, for example, a frame layer, a core library layer, and a drive layer, and is configured to implement various basic services and process hardware-based tasks.

A network communication module 452 is configured to reach another electronic device through one or more (wired or wireless) network interfaces 420. Exemplary network interfaces 420 include: Bluetooth, wireless fidelity (Wi-Fi), a universal serial bus (USB), and the like.

A presentation module 453 is configured to display information by one or more output apparatuses 431 (for example, display screens and speakers) associated with the user interface 430 (for example, a user interface configured to operate a peripheral device and display content and information).

An input processing module 454 is configured to detect one or more user inputs or interactions from the input apparatuses 432 and translate the detected inputs or interactions.

In some embodiments, the apparatus provided in this embodiment of the present disclosure may be implemented in a software manner. FIG. 2 shows an information presentation apparatus 455 stored in the memory 450. The apparatus 455 may be software in the form of a program and a plug-in, and the like, and includes the following software modules: a first display module 4551, a second display module 4552, and a third display module 4553. The modules are logical, so that the modules can be combined in different manners or further split based on achieved functions. Functions of the modules are described below.

In some other embodiments, the apparatus provided in embodiments of the present disclosure may be implemented in a hardware manner. As an example, the information presentation apparatus provided in embodiments of the present disclosure may be a processor in the form of a hardware decoding processor, programmed to perform the information presentation method provided in embodiments of the present disclosure. For example, the processor in the form of the hardware decoding processor may use one or more application-specific integrated circuits (ASICs), DSPs, programmable logic devices (PLDs), complex programmable logic devices (CPLDs), field-programmable gate arrays (FPGAs), or other electronic elements.

In some embodiments, the terminal or the server may implement the information presentation method provided in embodiments of the present disclosure by running a computer program. For example, the computer program may be a native program or a software module in an operating system; may be a native application (APP), namely, a program that needs to be installed in the operating system to run, like an instant messaging APP and a web page browser APP; or may be a mini program, namely, a program that only needs to be downloaded into a browser environment to run; or may be a mini program that can be embedded into any APP. In conclusion, the foregoing computer program may be any form of application, module, or plug-in.

Based on the foregoing descriptions of the information presentation system and the electronic device provided in embodiments of the present disclosure, the following describes an information presentation method provided in embodiments of the present disclosure. In one embodiment, the information presentation method provided in embodiments of the present disclosure may be implemented by a terminal or a server alone, or by a terminal and a server collaboratively. An example in which the terminal 400 in FIG. 1 performs the information presentation method provided in embodiments of the present disclosure alone is used for description. FIG. 3 is a schematic flowchart of an information presentation method according to an embodiment of the present disclosure. Descriptions are provided with reference to operations shown in FIG. 3.

Operation 101: The terminal displays a video played at a first playback speed on a video playback interface.

In one embodiment, the terminal is provided with an application client, like a video playback client, a social client, or an instant messaging client. The terminal may display the video playback interface by using the application client. Then, the video is played on the video playback interface. The video may be a specific TV series, a movie, a variety show, image data shot by a user, or the like. This is not limited in embodiments of the present disclosure.

The first playback speed may be a default playback speed, for example, a playback speed of 1×, or may be a playback speed set by the user, for example, a playback speed of 0.8× or 1.5×. This is not limited in embodiments of the present disclosure.

Operation 102: Play the video at a second playback speed less than the first playback speed and display guide information in response to that a playback adjustment condition of the video is satisfied, the guide information providing guidance for performing a target interactive operation on the video playback interface.

The second playback speed is less than the first playback speed, for example, may be 0 or any playback speed less than the first playback speed. For example, when the first playback speed is 133 during playback, if the playback adjustment condition of the video played on the video playback interface is satisfied, playback of the video may be paused. That is, the second playback speed is 0, or a playback speed of the video may be controlled to be less than 1×. For example, the second playback speed is 0.5×.

When the playback adjustment condition of the video played on the video playback interface is satisfied, whether the second playback speed is 0 may be predetermined, or may be determined based on the satisfied playback adjustment condition.

The playback adjustment condition includes at least one of the following: A playback duration of the video reaches a target duration; a playback pause operation on the video is received; the video is played to key content; currently-played video content is associated with target content; a current playback time point of the video is a key time point; and a slow-speed playback operation on the video is received. For example, when the slow-speed playback operation on the video is received, it is determined that the second playback speed is not 0, or when the playback pause operation on the video is received, it is determined that the second playback speed is 0. Alternatively, when the video is played to the key content, it is determined that the second playback speed is 0, or when the currently-played video content is associated with the target content, it is determined that the second playback speed is not 0.

When the playback adjustment condition of the video played on the video playback interface is satisfied, whether the second playback speed is 0 is determined based on the satisfied playback adjustment condition. A correspondence between the satisfied playback adjustment condition and whether the second playback speed is 0 includes but is not limited to the foregoing plurality of correspondences. This is not limited in embodiments of the present disclosure.

In one embodiment, to determine whether the playback duration of the video reaches the target duration, a currently-played playback duration of the video and the preset target duration, such as 10 minutes, are obtained in real time, then the obtained playback duration is compared with the target duration, and when a comparison result indicates that the playback duration of the video reaches the target duration, it is determined that the playback adjustment condition is satisfied.

One or more target durations may be set, for example, 10 minutes, 20 minutes, or 30 minutes, so that during video playback, whether the playback duration of the video reaches the target duration may be determined at intervals, to implement regular information presentation.

In one embodiment, for a process in which the playback pause operation on the video is received, a pause control may be displayed. The pause control is configured to pause a played video, so that a trigger operation on the pause control is determined as the playback pause operation on the video. Alternatively, the playback pause operation may be a tapping operation like a double-tapping operation on the played video, or may be a pressing operation on the played video. This is not limited in embodiments of the present disclosure. Therefore, when the playback pause operation on the video is received, it is determined that the playback adjustment condition is satisfied.

In one embodiment, for a process of determining, when the video is played to the key content and the currently-played video content is associated with the target content, that the playback adjustment condition is satisfied, before the playing the video at a second playback speed less than the first playback speed and displaying guide information in response to that a playback adjustment condition of the video is satisfied, the currently-played video content may be further obtained. If the currently-played video content is the key content of the video, or the currently-played video content is associated with the target content, it is determined that the playback adjustment condition is satisfied.

The key content may be climax content of the video, turning-point content of the video, or the like. That the currently-played video content is associated with the target content indicates a possibility of specifically performing an interactive operation on the currently-played content. For example, the target content is the same as an item displayed in the currently-played content. For example, if the target content is for cosmetics, when the video shows a girl applying makeup, the currently-played video content is associated with the target content. Alternatively, the target content may be configured for a specific scenario in the currently-played content. For example, if the target content is for toothpaste, when the currently-played video content is that a main character just gets out of bed, the currently-played video content is associated with the target content. A process of determining the possibility of specifically performing the interactive operation in the currently-played content may be implemented through image detection. For example, an image detection model detects an item displayed in the currently-played content or a specific scenario in the currently-played content, to determine, based on a detection result, the possibility of specifically performing the interactive operation in the currently-played content. That is, the target content is the same as the item displayed in the currently-played content or the target content may be configured for the specific scenario in the currently-played content.

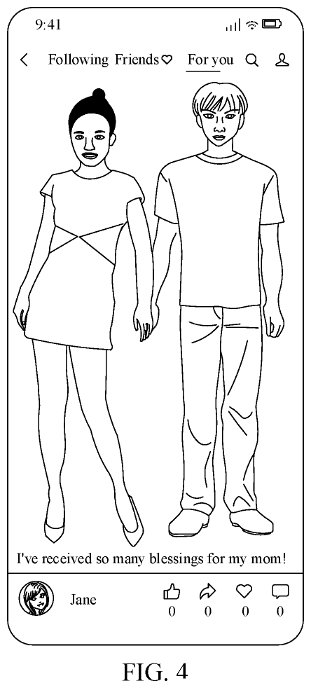

For example, FIG. 4 is a schematic diagram of pausing playback of a video according to an embodiment of the present disclosure. Based on FIG. 4, when the video is played to the key content, that is, content in which two main characters are about to hold hands as shown in FIG. 4, it is determined that the playback adjustment condition is satisfied. Therefore, the video is played at the second playback speed less than the first playback speed.

According to the foregoing embodiments, if the currently-played video content is the key content of the video, or the currently-played video content is associated with the target content, it is determined that the playback adjustment condition is satisfied. Therefore, the video is played at the second playback speed less than the first playback speed. In this way, by reducing the playback speed of the video, understanding and memorizing of the key content by viewers are enhanced, and overall quality and watching experience of the video content are improved, visibility and effect of the target content are improved, and interaction and response of the viewers to the promotion content are increased, thereby improving a conversion rate of the target content.

In one embodiment, for a process in which the slow-speed playback operation on the video is received, at least one playback speed control may be displayed. The playback speed control is configured to adjust the playback speed of the video, to determine a trigger operation on a target playback speed control in the at least one playback speed control as the slow-speed playback operation on the video. The target playback speed control is configured to instruct to adjust the playback speed of the video to a target playback speed threshold. The target playback speed threshold is less than a playback speed threshold. For example, the playback speed threshold may be a playback speed of 1×, and the target playback speed threshold be a playback speed of 0.5× or 0.25×.

Alternatively, the slow-speed playback operation may be a tapping operation like a double-tapping operation on a played video, or may be a pressing operation on a played video. This is not limited in embodiments of the present disclosure. Therefore, when the slow-speed playback operation on the video is received, it is determined that the playback adjustment condition is satisfied.

In one embodiment, for a process of determining, when the video is played to the key time point, that the playback adjustment condition is satisfied, during video playback, before the playing the video at a second playback speed less than the first playback speed and displaying guide information in response to that a playback adjustment condition of the video is satisfied, the current playback time point of the video may be further obtained. If the current playback time point of the video is the key time point of the video, it is determined that the playback adjustment condition is satisfied.

The key time point may be preset. For example, when the video is obtained, the key time point is marked for the video, to obtain at least one key time point of the video, so that during video playback, when the video is played to the key time point, it is determined that the playback adjustment condition is satisfied.

In one embodiment, the guide information may be in a plurality of forms, for example, a text form, an animation form, or a form of combining text and animation. Next, an example in which the guide information is in a form of combining text and animation is used to describe a process of displaying the guide information.

In some embodiments, the guide information includes a guide animation and guide text, so that the process of displaying the guide information may be: displaying the guide animation on the video playback interface, and displaying, in an associated area of the guide animation, the guide text corresponding to animation content of the guide animation, the guide animation being configured for presenting an operation manner for performing the target interactive operation.

The target interactive operation may be in a plurality of forms, for example, may be a sliding operation, a pressing operation, a blowing operation, a shaking operation, or a tapping operation. This is not limited in embodiments of the present disclosure. Based on this, for a specific target interactive operation, the operation manner for performing the target interactive operation, for example, sliding or blowing, may be presented based on the guide animation. In addition, in addition to being presented based on the guide animation, operation content of the target interactive operation, that is, the animation content of the guide animation, is further specifically described based on the guide text.

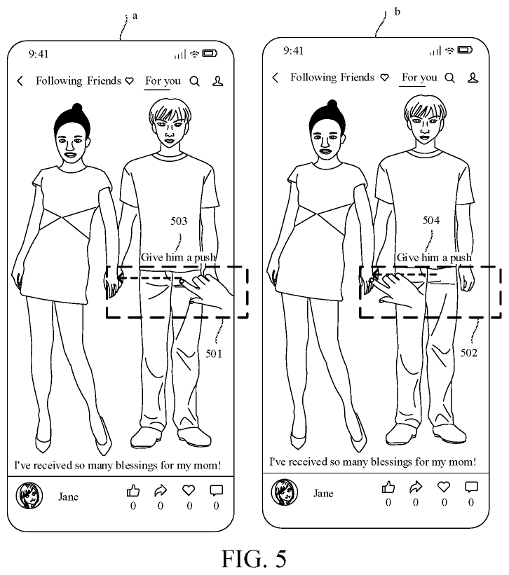

For example, FIG. 5 is a schematic diagram of guide information according to an embodiment of the present disclosure. Based on FIG. 5, a dashed-line box 501 in a and a dashed-line box 502 in b in FIG. 5 indicate the guide animation. The dashed-line box 501 to the dashed-line box 502 indicate a display process of the animation, and 503 in a and 504 in b indicate the guide text. In addition, the target interactive operation is a sliding operation, so that the guide animation that is configured for prompting to perform the sliding operation and that is indicated by the dashed-line box 501 in a and the dashed-line box 502 in b is displayed on the video playback interface, and the guide text that corresponds to the animation content of the guide animation and that is indicated by 503 in a and 504 in b is displayed in an upper area of the guide animation.

According to the foregoing embodiments, the operation manner for performing the target interactive operation is presented based on the guide animation. Because an animation effect can usually attract attention of the user, and improve engagement and interest of the user, the user performs the target interactive operation more positively. In addition, the guide animation can guide the user to perform an operation according to a correct operation, to help the user avoid a common mistake, thereby improving user experience.

In some embodiments, in the process of displaying the guide information, a video clip associated with the video content of the video is further played through a floating window in an associated area of the guide information, the video clip being video content of the video that is not played, and being configured for instructing to continue to play the video when the target interactive operation is completed.

The associated area may be one of an upper area, a lower area, a left area, and a right area of the guide information, and the video content of the video that is not played may be video content following paused playback or video content of the video when a playback speed of the video is controlled to be less than the playback speed threshold, for example, video content that needs to be played when the video continues to be played, or may be other video content that is not played. This is not limited in embodiments of the present disclosure. A length of the video clip may also be preset, for example, may be three seconds of video content. In this way, the user is attracted to complete the target interactive operation based on the video clip, to continue to play the video, thereby improving a possibility that the user performs the target interactive operation, and improving human-computer interaction rate.

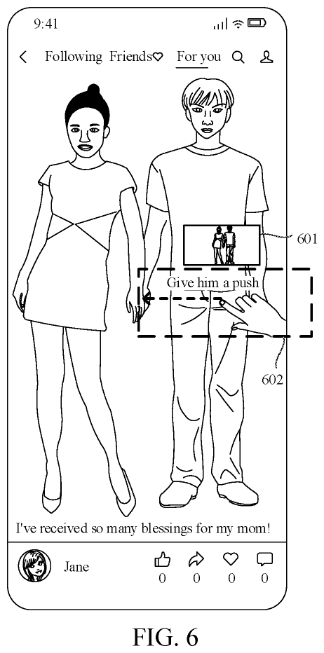

For example, FIG. 6 is a schematic diagram of playing a video clip associated with video content of a video through a floating window according to an embodiment of the present disclosure. Based on FIG. 6, 601 indicates the floating window, content of which is the video clip associated with the video content of the video. In an upper area of the guide information indicated by a dashed-line box 602, the video clip associated with the video content of the video is played through the floating window indicated by 601.

In actual application, the video clip associated with the video content of the video is played through the floating window, to attract the user to perform the target interactive operation, thereby improving utilization of display resources, and improving human-computer interaction efficiency and utilization of hardware resources of the electronic device.

In some embodiments, the guide information may be further related to an object type. The process of displaying the guide information may be: obtaining a target object type to which a target object playing the video belongs, different object types corresponding to different interactive operations, and the different interactive operations having different levels of operation difficulty; selecting the target interactive operation from a plurality of interactive operations based on the target object type; and displaying the guide information corresponding to the target interactive operation.

The object type may be determined based on object information of an object. The object information may be an age of the object, an account level of a used account on a client playing the video, historical behavior data of the object, or the like. This is not limited in embodiments of the present disclosure. The historical behavior data may be a purchase preference, a historical purchase record, a collection record, a commenting behavior, a liking behavior, a sharing behavior, or the like of the object, that is, the user.

In one embodiment, in addition to determining the object type, the object information may further correspond to different target content. Therefore, in a subsequent process, the playing the video at the first playback speed and displaying target content in response to that the target interactive operation is performed may be: playing the video at the first playback speed, obtaining target content corresponding to target object information, and displaying the target content in response to that the target interactive operation is performed.

In the process of displaying the guide information, the target object information of the target object playing the video is first obtained, then the target object type to which the target object belongs is determined based on the target object information, and the target content matching the target object is further predicted based on the target object information by using a pre-trained promotion model, to display the target content.

Because different object information corresponds to different target content, when the target content varies, the target interactive operation may also vary, so that an interaction path of the target interactive operation may also vary. For example, when it is determined, based on the object information, that the target interactive operation is a sliding operation, the interaction path of the target interactive operation is a sliding trajectory of the sliding operation. When it is determined, based on the object information, that the target interactive operation is a shaking operation, the interaction path of the target interactive operation is a shaking trajectory of the shaking operation. In addition, even if it is determined, based on the object information, that target interactive operations of different objects are all sliding operations, because the object information varies, sliding trajectories of the sliding operations may also vary. This is not limited in embodiments of the present disclosure.

According to the foregoing embodiments, different object types correspond to different interactive operations, and different interactive operations have different levels of operation difficulty, so that corresponding guide information is displayed based on the object type to which the target object belongs. In this way, diversity of the guide information is enriched, and a probability that the target object performs the target interactive operation based on the guide information is improved, thereby improving human-computer interaction efficiency and utilization of hardware resources of the electronic device.

Operation 103: Play the video at the first playback speed and display the target content in response to that the target interactive operation is performed.

The target content is configured for promoting an item, for example, an advertisement. In addition, the target content may also be an image or text, or may include a video, an animation, an interactive game, or other forms. In this way, more diversified promotion manners are provided to advertisers, thereby improving diversity of information presentation manners during video playback.

In one embodiment, the playing the video at the first playback speed and displaying target content in response to that the target interactive operation is performed may be: playing the video at the first playback speed and displaying the target content in response to that the target interactive operation is performed and when the target interactive operation satisfies an operation condition; or displaying operation prompt information when the target interactive operation does not satisfy the operation condition, the operation prompt information being configured for prompting that the target interactive operation does not satisfy the operation condition, and the target interactive operation needs to be performed again.

The operation condition may be preset, and a specific operation condition varies based on a difference in the target interactive operations. For example, when the target interactive operation is a sliding operation, the operation condition may be whether the sliding operation matches a sliding trajectory, whether the sliding operation reaches a sliding length, or the like. When the target interactive operation is a blowing operation, the operation condition may be whether a sound pressure level generated by the blowing operation reaches a target sound pressure level. When the target interactive operation is a shaking operation, the operation condition may be whether a tilt angle of the shaking operation reaches a target angle, whether a shaking distance reaches a target distance, or the like. Next, a process of displaying the target content in response to that the target interactive operation is performed is described by using three target interactive operations as examples.

In some embodiments, the target interactive operation includes a sliding operation, and the guide information includes a target sliding trajectory and prompt information configured for prompting to perform the sliding operation based on the target sliding trajectory. Therefore, the playing the video at the first playback speed and displaying target content in response to that the target interactive operation is performed may be: displaying a current sliding trajectory of the sliding operation in response to that the sliding operation is performed; and playing the video at the first playback speed and displaying the target content when the current sliding trajectory of the sliding operation matches the target sliding trajectory.

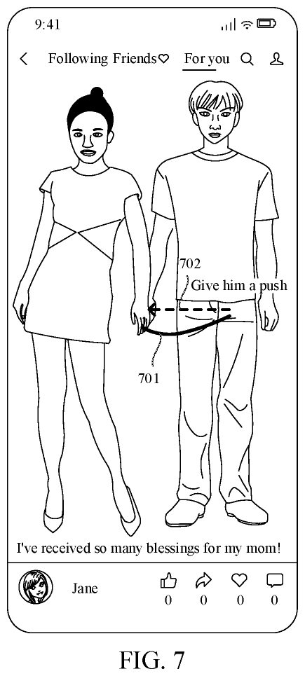

For example, FIG. 7 is a schematic diagram of a current sliding trajectory according to an embodiment of the present disclosure. Based on FIG. 7, 701 indicates the current sliding trajectory, and 702 indicates the target sliding trajectory, so that when the current sliding trajectory that is of the sliding operation and that is indicated by 701 matches the target sliding trajectory, the video is played, and the target content is displayed.

The target sliding trajectory may be preset and may be related to the object information of the user. The object information may be the age of the user, the account level of the used account on the client playing the video, or the like. For example, a larger age of the user indicates higher complexity set for the target sliding trajectory. This is not limited in embodiments of the present disclosure.

In one embodiment, when a matching degree between the current sliding trajectory of the sliding operation and the target sliding trajectory reaches a matching degree threshold, it is determined that the current sliding trajectory of the sliding operation matches the target sliding trajectory, to play the video and display the target content. The matching degree threshold may be preset, for example, may be 90%.

According to the foregoing embodiments, if the target interactive operation is the sliding operation, the video is played at the first playback speed and the target content is displayed only when the sliding trajectory of the sliding operation matches the target sliding trajectory. In this way, a case of an accidental touch by the user is avoided, and human-computer interaction efficiency is improved.

In some other embodiments, when the current sliding trajectory of the sliding operation does not match the target sliding trajectory, the target sliding trajectory is switched to a new target sliding trajectory.

The new target sliding trajectory is obtained by updating the target sliding trajectory based on the current sliding trajectory, and similarity between the new target sliding trajectory and the current sliding trajectory reaches a similarity threshold. The similarity threshold may be preset, for example, may be 80%. In addition, complexity of the new target operation trajectory may also be less than that of the current operation trajectory, to reduce difficulty in matching sliding trajectories. This allows the user to perform a new sliding operation based on the new target sliding trajectory, and therefore, a current sliding trajectory of the new sliding operation matches the target sliding trajectory.

When the matching degree between the current sliding trajectory of the sliding operation and the target sliding trajectory does not reach the matching degree threshold, it is determined that the current sliding trajectory of the sliding operation does not match the target sliding trajectory, and then first sliding information of the sliding operation is obtained, for example, specific information such as a sliding speed, a sliding direction, sliding time, and a sliding amplitude. Meanwhile, the sliding trajectory is analyzed to obtain second sliding information, for example, including but not limited to locations of sliding start and end points, a sliding distance and sliding time, a sliding speed, and the like. Next, based on the first sliding information and the second sliding information, a sliding habit and tendency of the user are obtained through analysis. Finally, based on the sliding habit and tendency of the user, a possible sliding path of the user is predicted by using a pre-trained trajectory prediction model, so that the current sliding trajectory of the sliding operation is adjusted based on the possible sliding path of the user, to obtain the new target sliding trajectory.

In actual application, if the target interactive operation is the sliding operation, and the sliding trajectory of the sliding operation of the user does not match the target sliding trajectory, the target sliding trajectory is adjusted, to reduce complexity of the new target sliding trajectory. This allows the user to perform the new sliding operation based on the new target sliding trajectory. Therefore, difficulty in completing the target interactive operation is reduced, a success rate of the target interactive operation is improved, and human-computer interaction efficiency is improved.

In some embodiments, the guide information includes an interactive element and prompt information configured for prompting to perform a blowing operation on the interactive element, and the target interactive operation includes the blowing operation on the interactive element. Therefore, the playing the video at the first playback speed and displaying target content in response to that the target interactive operation is performed may be: displaying, in response to that the blowing operation on the interactive element is performed, a process in which the interactive element is blown up; and playing the video at the first playback speed and displaying the target content when a height at which the interactive element is blown up reaches a height threshold, or a size at which the interactive element is blown up reaches a size threshold.

A style of the interactive element may be preset, for example, an item that can be blown up such as a tree leaf or a feather. The prompt information configured for prompting to perform the blowing operation on the interactive element may be text information, for example, “please blow up the feather”, or may be animation information, for example, an animation of blowing up a feather. This is not limited in embodiments of the present disclosure.

In one embodiment, when the user blows, a specific sound pressure level is generated. Therefore, when the blowing operation of the user on the interactive element is received, that is, the blowing operation on the interactive element is performed, a change of a sound pressure level generated based on the blowing operation of the user is detected by using a sound pressure sensor included in the terminal, that is, the specific sound pressure level is generated, and then the change of the sound pressure level is associated with a blowing phenomenon, that is, when the specific sound pressure level is generated, it is determined that the user performs the blowing operation, to display a process in which the interactive element is blown up. The height threshold and the size threshold may also be preset, for example, may be set based on the object information as described above. Different objects correspond to different height thresholds and size thresholds. This is not limited in embodiments of the present disclosure.

When the height at which the interactive element is blown up does not reach the height threshold or the size at which the interactive element is blown up does not reach the size threshold, the height threshold or the size threshold is adjusted to obtain a new height threshold or a new size threshold, so that when performing the blowing operation again based on the operation prompt information, the user can determine, based on the new height threshold or the new size threshold, whether to play the video and display the target content.

A process of adjusting the height threshold or the size threshold to obtain the new height threshold or the new size threshold is similar to the foregoing process of updating the target sliding trajectory based on the current sliding trajectory to obtain the new target sliding trajectory. This is not described in detail in embodiments of the present disclosure.

According to the foregoing embodiments, if the target interactive operation includes the blowing operation on the interactive element, the video is played at the first playback speed and the target content is displayed when the height at which the interactive element is blown up reaches the height threshold, or the size at which the interactive element is blown up reaches the size threshold. In this way, types of target interactive operations are enriched, diversity of processes in which the target interactive operation is performed is improved, user experience is improved, and human-computer interaction efficiency and utilization of hardware resources of the electronic device are improved.

In some embodiments, the guide information includes an interactive element and prompt information configured for prompting to perform a shaking operation on the terminal playing the video, and the target interactive operation includes the shaking operation on the terminal. Therefore, the playing the video at the first playback speed and displaying target content in response to that the target interactive operation is performed may be: displaying, in response to that the shaking operation on the terminal is performed, a process in which the interactive element moves from a current position to a target position; and playing the video at the first playback speed and displaying the target content when the interactive element moves to the target position.

Prompting to perform the shaking operation on the terminal playing the video is performing the shaking operation on the interactive element. A style of the interactive element may be preset, for example, a ball-like item. In addition, the target position is also preset, and may be marked on the video playback interface, for example, may be highlighted by using a special effect. The prompt information configured for prompting to perform the shaking operation on the interactive element, that is, to perform the shaking operation on the terminal playing the video, may be text information, for example, “please move the ball to the target position”, or may be animation information, for example, an animation of moving the ball to the target position. This is not limited in embodiments of the present disclosure.

In one embodiment, when the shaking operation of the user on the terminal is received, a tilt angle of the device relative to a horizontal plane is calculated by using a gravity sensor, to determine a movement manner of the device, and then the interactive element is controlled to be correspondingly moved based on the movement manner of the device.

When the interactive element is not moved to the target position, the target position is adjusted to obtain a new target position, so that when performing the shaking operation again based on the operation prompt information, the user can determine, based on the target position, whether to play the video and display the target content.

A process of adjusting the target position to obtain the new target position is similar to the foregoing process of updating the target sliding trajectory based on the current sliding trajectory to obtain the new target sliding trajectory. This is not described in detail in embodiments of the present disclosure.

In actual application, if the target interactive operation includes the shaking operation on the terminal, the video is played at the first playback speed and the target content is displayed when the interactive element is moved to the target position. In this way, types of target interactive operations are enriched, diversity of processes in which the target interactive operation is performed is improved, human-computer interaction efficiency and utilization of hardware resources of the electronic device are improved, and user experience is improved.

In some embodiments, the target interactive operation corresponds to a plurality of pieces of operation content, and different operation content corresponds to different target content. Therefore, the playing the video at the first playback speed and displaying target content in response to that the target interactive operation is performed may be: playing the video at the first playback speed and displaying target content corresponding to the operation content of the target interactive operation, in response to that the target interactive operation is performed.

As described above, a quantity of target interactive operations is more than one. Different target interactive operations correspond to different operation content. For example, the target interactive operation may be a sliding operation, a blowing operation, a shaking operation, or the like. When the target interactive operation is a sliding operation, the operation content is a sliding path for the currently-played video content. When the target interactive operation is a blowing operation, the operation content is a height or a size at which the interactive element is blown up. When the target interactive operation is a shaking operation, the operation content is a target position to which the interactive element is finally moved. This is not limited in embodiments of the present disclosure. Next, an example in which the target interactive operation is the sliding operation is used to describe a process in which the video is played in response to that the target interactive operation is received, and the target content corresponding to the operation content of the target interactive operation is displayed.

According to the foregoing embodiments, if the target interactive operation corresponds to the plurality of pieces of operation content, and the different operation content corresponds to the different target content, when the target interactive operation is performed, the target content corresponding to the operation content of the target interactive operation is displayed. In this way, when the user performs a particular target interactive operation, target content strongly related to operation content of the target interactive operation may be presented. This increases attractiveness of the target content. In addition, because the target content is directly related to the operation content of the user, the user is more likely to be interested in the information, thereby improving engagement and interaction of the user, and further improving a conversion rate of the target content.

In some embodiments, the target interactive operation includes the sliding operation, the operation content is the sliding path for the currently-played video content, the guide information includes a plurality of sliding paths and prompt information for the sliding path, and the prompt information is configured for prompting to perform the sliding operation on the video content based on at least one of the plurality of sliding paths. Therefore, the playing the video at the first playback speed and displaying target content corresponding to the operation content of the target interactive operation, in response to that the target interactive operation is performed, may be: playing the video at the first playback speed and displaying target content corresponding to a target sliding path, in response to that a sliding operation for the target sliding path in the plurality of sliding paths is performed.

Different operation content may indicate different sliding paths corresponding to sliding operations, for example, may indicate sliding leftwards, sliding rightwards, or the like. The different sliding paths correspond to different target content. For example, when sliding leftwards is performed, target content corresponding to a sliding path of sliding leftwards is displayed, and when sliding rightwards is performed, target content corresponding to a sliding path of sliding rightwards is displayed. Target content corresponding to each piece of operation content is preset. This is not limited in embodiments of the present disclosure.

In actual application, if the target interactive operation is the sliding operation, and the different sliding paths of the sliding operations correspond to different video content, when the sliding operation is performed, the target content corresponding to the target sliding path of the sliding operation is displayed. In this way, the target content is dynamically generated based on the sliding path of the sliding operation of the user. This improves user experience, reduces a possibility of information overload, and makes the target content more intelligent, thereby ensuring that the target content better conforms to preferences and requirements of the user, and further improving a conversion rate of the target content.

In one embodiment, the different operation content is further configured for indicating different video content when the video continues to be played. Therefore, a process of playing the video may be continuing to play target video content. The target video content corresponds to the operation content of the target interactive operation.

When the sliding operation for the target sliding path in the plurality of sliding paths is received, the target video content may continue to be played while the target content corresponding to the target sliding path is displayed. Alternatively, after the target content corresponding to the target sliding path is displayed, display of the target content is canceled, and the target video content continues to be played. This is not limited in embodiments of the present disclosure.

The target video content corresponding to the operation content of the target interactive operation means that video content of the video that continues to be played varies as the operation content of the target interactive operation performed by the user varies. For example, when the target interactive operation is the sliding operation, when the user performs a leftward sliding operation, target video content corresponding to a sliding path of sliding leftwards continues to be played. When the user performs a rightward sliding operation, target video content corresponding to a sliding path of sliding rightwards continues to be played.

For example, if a main character in the video is lost and faces two ways when playback of the video is paused, the guide information including the plurality of sliding paths and the prompt information for the sliding paths is displayed. Therefore, when the user performs sliding leftwards, target video content in which the main character in the video travels to the left continues to be played. When the user performs the rightward sliding operation, target video content in which the main character in the video travels to the right continues to be played.

The operation content may be strongly related to the video content, as described in the foregoing examples, or may correspond only to the video content and is not strongly related to the video content. For example, according to the foregoing examples, the sliding path may be an upward sliding path or a downward sliding path. When the user performs sliding upwards, target video content in which the main character in the corresponding video travels to the left continues to be played. When the user performs a downward sliding operation, target video content in which the main character in the corresponding video travels to the right continues to be played. This is not limited in embodiments of the present disclosure.

According to the foregoing embodiments, if the different operation content of the target interactive operation is further configured for indicating the different video content when the video continues to be played, when the target interactive operation is performed, the target content corresponding to the operation content of the target interactive operation is also displayed. In this way, the target content is dynamically generated based on the operation content of the target interactive operation. This improves user experience, reduces a possibility of information overload, and makes the target content more intelligent, thereby ensuring that the target content better conforms to preferences and requirements of the user, and further improving a conversion rate of the target content.

In some embodiments, different target content may also be displayed based on a quantity of objects on which the target interactive operation is currently performed online. The playing the video at the first playback speed and displaying target content in response to that the target interactive operation is performed may be: playing the video at the first playback speed and displaying first target content if the quantity of objects on which the target interactive operation is currently performed online reaches a target quantity, in response to that the target interactive operation is performed; or displaying second target content if the quantity of objects on which the target interactive operation is currently performed online does not reach the target quantity, the second target content being different from the first target content.

The target quantity may be preset. In addition, the first target content differs from the second target content in that promotion intensity of the first target content is different from that of the second target content. For example, when the first target content and the second target content promote the same product, a discount corresponding to the first target content is greater than a discount corresponding to the second target content, or when the first target content and the second target content promote different products, popularity of the product promoted by the first target content is greater than popularity of the product promoted by the second target content. The popularity is determined based on a sales volume, a quantity of collections, and the like of a corresponding product. Alternatively, when the first target content and the second target content promote different products, a value of the product promoted by the first target content is greater than a value of the product promoted by the second target content. This is not limited in embodiments of the present disclosure. That is, a larger quantity of objects on which the target operation is currently performed indicates larger promotion intensity of the target content.

In actual application, the displayed target content is determined depending on whether the quantity of objects on which the target interactive operation is currently performed online reaches the target quantity. In this way, types of the target content are enriched, human-computer interaction efficiency and utilization of hardware resources of the electronic device are improved, and user experience is improved, thereby improving a conversion rate of the target content.

In some embodiments, after the playing the video at the first playback speed and displaying target content in response to that the target interactive operation is performed, an atmosphere element corresponding to the target content may be further displayed, the atmosphere element being in a special effect state and being configured for enhancing a visual effect of the target content.

The special effect state may refer to states such as glowing or flashing. Different target content corresponds to different atmosphere elements. The atmosphere element is configured for creating a particular atmosphere or emotional state, to enhance expressiveness and appeal of the target content.

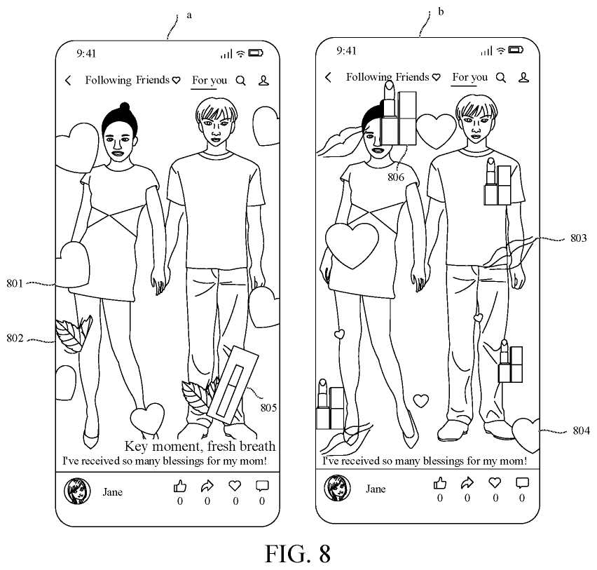

For example, FIG. 8 is a schematic diagram of an atmosphere element according to an embodiment of the present disclosure. Based on FIG. 8, target content in a in FIG. 8 is target content of a breath freshener, and an atmosphere element of the target content may be a heart indicated by 801 in a and a mint leaf indicated by 802. In this case, a visual effect of the target content is enhanced based on the atmosphere elements indicated by 801 and 802 in a. Correspondingly, target content in b in FIG. 8 is target content of a lipstick, and an atmosphere element of the target content may be a heart indicated by 804 in b and a lip print indicated by 803 in b. In this case, a visual effect of the target content is enhanced based on the atmosphere elements indicated by 803 and 804 in b.

According to the foregoing embodiments, when the target content is displayed, the atmosphere element configured for enhancing the visual effect of the target content is further displayed. In this way, the atmosphere element can increase visual attractiveness of the target content, and help highlight the target content, so that key content of the target content can be more quickly conveyed to the user, thereby improving information transmission efficiency and a conversion rate of the target content.

In one embodiment, a quantity of atmosphere elements may be more than one. Therefore, the displaying an atmosphere element corresponding to the target content may be: displaying, on the video playback interface, a process in which the plurality of atmosphere elements appear from a first end of the playback interface, move to a second end of the playback interface, and disappear from the second end, at least two of the plurality of atmosphere elements having different appearing time or different moving speeds. Alternatively, the interactive element may be presented on the video playback interface in the form of a functional item, a text link, or an indication connection. Appearing time of the interactive elements is the same.

The atmosphere element may be interactive, so that a page jump is performed from the video playback interface to a landing page of the target content in response to a trigger operation on a target atmosphere element in the plurality of atmosphere elements. The landing page may include detailed information, such as a name, a price, and efficacy of an item corresponding to the target content, and may be, for example, a purchase page, a reading page, or a download page of the item corresponding to the target content. This is not limited in embodiments of the present disclosure.

For example, when the atmosphere element is presented on the video playback interface in the form of a text link, a text link “join us” is displayed on the playback interface, and then a page jump is performed to a corresponding landing page in response to a page jump instruction triggered for the text link “join us”. Alternatively, when the atmosphere element is presented on the video playback interface in the form of a red packet rain, the red packet rain is displayed on the playback interface, and then a page jump is performed to a corresponding landing page in response to a page jump instruction triggered by a tapping operation on a red packet in the red packet rain.

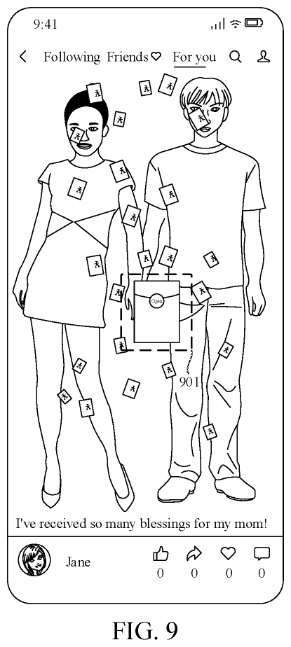

For example, FIG. 9 is a schematic diagram of an atmosphere element according to an embodiment of the present disclosure. Based on FIG. 9, the atmosphere element is presented on the video playback interface in the form of the red packet rain, and then the page jump is performed from the video playback interface to the landing page of the target content in response to a page jump instruction triggered based on an atmosphere element indicated by a dashed-line box 901.

In actual application, the plurality of atmosphere elements appear from the first end of the playback interface, move to the second end of the playback interface, and disappear from the second end. In this way, diversity of processes of displaying the atmosphere element of the target content is improved, thereby improving utilization of display resources and visual experience of the user.

In some embodiments, the target content includes the interactive element. After the playing the video at the first playback speed and displaying target content in response to that the target interactive operation is performed, the page jump may be further performed from the video playback interface to the landing page of the target content in response to the trigger operation on the interactive element.

The interactive element is similar to the atmosphere element described above. However, in addition to the atmosphere element, the interactive element may alternatively be a pattern element configured for indicating the item corresponding to the target content, for example, a pattern of the item corresponding to the target content. This is not limited in embodiments of the present disclosure. For example, as shown in FIG. 8, the interactive elements may be the atmosphere elements indicated by 801 and 802 in a, 803 and 804 in b, or may be patterns that are of items corresponding to the target content and that are indicated by 805 in a and 806 in b.

According to the foregoing embodiments, the page jump is performed from the video playback interface to the landing page of the target content based on a tapping operation on the interactive element. In this way, a conversion rate of the target content may be improved, and human-computer interaction efficiency and utilization of hardware resources of the electronic device may be improved.

In some embodiments, in a process of displaying the target content, the video content may continue to be played. In addition, a close control for the target content is displayed, the close control being configured to cancel display of the target content.

The video content that continues to be played and the target content are displayed together. In addition, because the close control is displayed, when the user wants to watch only the video, the user can perform a trigger operation on the close control, so that display of the target content is canceled in response to the trigger operation on the close control. In this way, based on the close control, the target content may be closed when the user wants to watch only the video, thereby improving user experience and human-computer interaction efficiency.

In some other embodiments, after the playing the video at the first playback speed and displaying target content in response to that the target interactive operation is performed, a display duration for the target content may be further displayed; and display of the target content may be canceled when the display duration reaches a target display duration, and the video content may continue to be played.

The target display duration may be preset, for example, may be 20 seconds. When the display duration does not reach the target display duration, the target content is continuously displayed. When the display duration reaches the target display duration, display of the target content is canceled. In this way, based on the display duration for which the target content is displayed, the user is prompted with time after which display of the target content can be canceled. In this way, a possibility that the user completely watches the target content is increased, so that an exposure rate of the target content is ensured, to increase a conversion rate of the target content.

In some embodiments, after the playing the video at the first playback speed and displaying target content in response to that the target interactive operation is performed, a switch control may be further displayed, the switch control being configured to switch the target content; and the target content may be switched to new target content in response to a trigger operation on the switch control.

A position of the switch control on the video playback interface may be preset. The trigger operation on the switch control may be a tapping operation on the switch control, for example, a single-tapping operation or a double-tapping operation. The new target content may be associated with the target content, or may be unassociated with the target content. This is not limited in embodiments of the present disclosure.

In actual application, the displayed target content may be switched by using the switch control. In this way, when the user wants to switch the target content, the user may switch the target content based on the switch control, thereby improving user experience and human-computer interaction efficiency.

In one embodiment, when the switch control is displayed, switch prompt information carried in the switch control is further displayed, the switch prompt information being configured for prompting a reward after the trigger operation is performed. Therefore, after the switching the target content to new target content in response to a trigger operation on the switch control, a virtual resource may be further displayed, the virtual resource being associated with the new target content and used as the reward for the trigger operation on the switch control.

The virtual resource may be configured for an item corresponding to the target content, for example, a voucher or a red envelope when the item is purchased. The switch prompt information may be a message like “tap to get a red envelope”. This is not limited in embodiments of the present disclosure.

In one embodiment, the switch prompt information may be further configured for prompting content of the new target content. Therefore, the switching the target content to new target content in response to a trigger operation on the switch control may be: switching the target content to the new target content in response to the trigger operation that is triggered based on the switch prompt information and that is on the switch control. The content configured for prompting the new target content means, for example, giving a preview of promotion content of the new target content. This is not limited in embodiments of the present disclosure.

According to the foregoing embodiments, the reward after the trigger operation is performed may be prompted based on the switch prompt information. In this way, the user is encouraged to perform the trigger operation on the switch control, thereby improving human-computer interaction efficiency and utilization of hardware resources of the electronic device.

In some embodiments, when the target content is displayed, at least one interaction control for the target content may be further displayed, the interaction control being configured to instruct to perform an interactive operation for the target content, and different interaction controls indicating different interactive operations. Therefore, the target interactive operation indicated by the target interaction control is performed for the target content in response to a trigger operation on a target interaction control in the at least one interaction control.

The interaction control be a share control, a favorite control, a like control, a comment control, and the like. Therefore, the target interactive operation indicated by the target interaction control is performed for the target content in response to the trigger operation on the target interaction control in the at least one interaction control. For example, the target content is shared to another object or another platform in response to a trigger operation on a share control in the at least one interaction control. Alternatively, the target content is commented in response to a trigger operation on a comment control in the at least one interaction control. In this way, based on the interactive operation performed for the target content, the target content may be commented, or the target content may be shared to another platform, thereby further strengthening interaction of the user, and improving reach and popularity of the target content.

In actual application, after the at least one interaction control of the target content is displayed, the target interactive operation indicated by the target interaction control may be performed for the target content in response to the trigger operation on the target interaction control in the at least one interaction control. In this way, an interaction process of the user for the target content is enriched by using the interaction control, thereby improving human-computer interaction efficiency and utilization of hardware resources of the electronic device.

In some embodiments, the playing the video at a second playback speed less than the first playback speed in response to that a playback adjustment condition of the video is satisfied may be: playing the video at the second playback speed less than the first playback speed in response to that the playback adjustment condition of the video is satisfied and when an object level of a target object that triggers a playback event of the video does not reach a level threshold.

The target object that triggers the playback event of the video is a user playing the video, the object level of the target object refers to an account level of an account used by the user on a client playing the video, and the level threshold may be preset. This is not limited in embodiments of the present disclosure.

When the playback adjustment condition of the video is satisfied, the object level of the target object and the preset level threshold are obtained. When the object level of the target object does not reach the level threshold, the video is played at the second playback speed less than the first playback speed.

In addition, the video continues to be played at the first playback speed when the object level of the target object reaches the level threshold.

That the video continues to be played at the first playback speed when the object level of the target object reaches the level threshold means that, if the object level of the target object reaches the level threshold, a playback speed of the video remains unchanged, and the video continues to be played at the first playback speed.

According to the foregoing embodiments, when the object level of the target object does not reach the level threshold, the video is played at the second playback speed less than the first playback speed. When the object level of the target object reaches the level threshold, the playback speed of the video remains unchanged, and the video continues to be played at the first playback speed. In this way, the level threshold is set, so that the user is encouraged to increase the object level of the user. This enriches diversity of video playback processes, and can improve human-computer interaction efficiency and utilization of hardware resources of the electronic device.

In one embodiment, the playing the video at the second playback speed less than the first playback speed in response to that the playback adjustment condition of the video is satisfied and when an object level of a target object that triggers a playback event of the video does not reach a level threshold may be: obtaining a mapping relationship between the object level of the target object and the playback speed of the video in response to that the playback adjustment condition of the video is satisfied and when the object level of the target object that triggers the playback event of the video does not reach the level threshold; and determining the second playback speed based on the object level of the target object and the mapping relationship, and playing the video at the second playback speed.

The mapping relationship between the object level of the target object and the playback speed of the video is preset. In addition, the object level of the target object is positively correlated with the playback speed of the video. For example, a higher object level of the target object indicates a faster playback speed of the video, that is, a higher second playback speed. This is not limited in embodiments of the present disclosure.

In actual application, the second playback speed of the video is determined based on the object level of the target object. In this way, the user is further encouraged to increase the object level of the user, thereby improving human-computer interaction efficiency and utilization of hardware resources of the electronic device, and also enriching diversity of video playback processes.

According to the foregoing embodiments, first, in a process of playing the video at the first playback speed, when the playback adjustment condition of the video is satisfied, a playback speed of the video is switched to the second playback speed less than the first playback speed, and the guide information for guiding to perform the target interactive operation on currently-played video content is displayed. Therefore, based on the guide information, in response to that the target interactive operation is performed, the playback speed of the video is restored to the first playback speed, and the target content is displayed. In this way, the video is played based on the target interactive operation performed by the user on the currently-played video content, and the target content is displayed, thereby not only improving interaction engagement of the user and a sense of participation of the user on the currently-played video content, but also improving diversity of information presentation manners during video playback, and improving human-computer interaction efficiency and utilization of hardware resources of the electronic device.

The following describes exemplary application of embodiments of the present disclosure in an actual application scenario.

When an advertisement is delivered during video playback, the following problems generally exist. First, the advertisement is usually played at a fixed time point of a video, and cannot be flexibly adjusted based on a plot change and an interaction situation of a user. This may affect watching experience of the user. Second, during regular video playback, user engagement is low, and the user can only passively receive information. Third, abruptness and irrelevance of the advertisement may lead to user aversion, resulting in reduced effect of the advertisement. Fourth, satisfaction of a personalized requirement of the user is usually ignored.

Based on this, an embodiment of the present disclosure provides a method for pausing video playback, resuming playback through interaction, and presenting an advertisement based on user interaction. Different from a conventional advertisement insertion manner, in the method, interaction pausing is performed at a plot climax or a key node based on features of the video, an advertisement element is introduced simultaneously, and playback of the video is resumed through interaction between the user and a player, to create richer user experience and improve a presentation effect of the advertisement (target content).

The following describes the technical solution of the present disclosure from a product side. As shown in FIG. 5, FIG. 7, and FIG. 8, the user watches a key plot on a video watching interface, video playback is paused, and animated guidance (guide information) is displayed simultaneously. Therefore, after the user performs a sliding operation based on the animated guidance, a sliding trajectory is displayed. When it is detected that a trajectory matching degree of the sliding trajectory is insufficient, a guide animation continues to be displayed. When the sliding trajectory matches, the video continues to be played, and the advertisement and an atmosphere element are presented.

In a process in which the user watches a short drama, when a key node or a plot climax is reached, the player automatically pauses, then the player displays interaction guidance based on a preset interaction path, and generates a corresponding animated trajectory based on the preset interaction path, to guide the user to perform an operation through a series of actions such as sliding, dragging, and tapping. Then, the user performs interaction based on the animated trajectory, and a mobile phone terminal detects a touch point and an interaction path. If it is detected that the interaction path of the user does not match the preset interaction path, the player strengthens the interaction guidance, and dynamically adjusts an interaction guidance trajectory based on an operation habit of the user. In addition, the interaction path and the advertisement element are improved by analyzing and predicting a response of the user through an AI technology. If the interaction path of the user accurately matches the preset path, the player resumes video playback and simultaneously presents one or more advertisement elements such as an atmosphere element, a red packet, or another element including an advertisement benefit.

If it is detected that the interaction path of the user does not match the preset interaction path, first, the player continues to present an animated interaction guidance, and displays text information, to guide the user to perform an operation more intuitively and clearly, so as to strengthen the interaction guidance; next, the player dynamically adjusts the interaction guidance trajectory based on the operation habit of the user, to implement an interaction path layout closer to an individual operation behavior; and then, the player automatically analyzes and predicts a feedback response of the user to the interaction path and the advertisement element through the AI technology like machine learning, thereby improving design of the interaction path and the advertisement element. In addition, a personalized user rating system may be designed, and interaction paths of different levels may be set based on a technical proficiency level of each user. For users of different levels, interaction manners matching operation habits and capability levels of the users are provided, thereby reducing learning costs of the users and improving use experience. In addition, in combination with an interaction effect of the user, a subsequent tapping situation of the advertisement element, and the like, an effective feedback rating system may be established, to evaluate an acceptance degree of the user for an interaction procedure, and strongly guide product iteration.

When it is detected that the interaction path of the user accurately matches the preset path, first, the player resumes video playback and simultaneously presents one or more advertisement elements such as an atmosphere element, a red packet, or another element including an advertisement benefit; next, a personalized advertisement element is accurately delivered in combination with big data analysis, for example, a customized advertisement element like a red packet or a coupon is provided based on a user preference and behavior feature; then, video content is accurately matched with advertisement content, to ensure that the advertisement element is displayed at the first time after playback is resumed, thereby improving effectiveness of the advertisement; and in addition, different advertisements are determined based on a quantity of users performing the target interactive operation in real time, thereby not only enhancing a sense of participation of the users, but also enabling an advertising effect to be rapidly propagated in a social network.

In this way, in a process of interacting with the player, the user is initially guided by the preset interaction path, and performs a series of operations such as sliding, dragging, and tapping. The operation data is collected and analyzed, and is used as an important input of the behavior feature of the user, for example, a plot node at which the user is more willing to interact, and a preferred interaction manner. In addition, based on a series of behavior manifestations of the user, feedback responses of the user to the interaction process and the advertisement element are automatically analyzed and predicted through the AI technology like machine learning. These responses, as feedback, are also configured for improving design of the interaction path and the advertisement element. In addition, in combination with the behavior feature and the feedback of the user, a suitable personalized advertisement can be accurately delivered. For example, corresponding designed advertisement elements such as a red envelope and a coupon are delivered based on an operating preference and habit of the user, to improve attention and an acceptance rate of the user to the advertisement. In addition, when it is successfully recognized that a user has a high response to and acceptance of some advertisement elements, the system can even dynamically adjust a delivery strategy for the advertisement elements, thereby further improving an advertisement effect. In conclusion, through collecting and analyzing of the interaction path and the feedback of the user, according to the technical solution of the present disclosure, accurate division and targeted delivery of advertisements can be implemented, to effectively improve acceptance of the advertisements, thereby greatly improving the advertising effect.

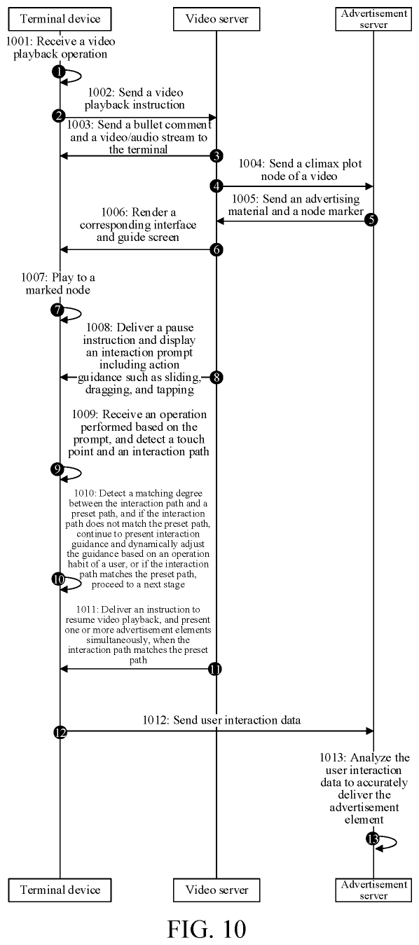

Next, the technical solution of the present disclosure is described from a technology side. FIG. 10 is a schematic diagram of a process of a method for pausing video playback, resuming playback through interaction, and presenting an advertisement based on user interaction according to an embodiment of the present disclosure. Based on FIG. 10, the method for pausing the video playback, resuming the playback through the interaction, and presenting the advertisement based on the user interaction provided in embodiments of the present disclosure may be implemented through operation 1001 to operation 1013. Based on a user terminal device, a user starts watching a video by using the terminal device, and the device records an interaction behavior of the user. A video server sends video data to the user terminal device for playing, is responsible for triggering a playback pause and presenting interaction guidance at a key moment, and displays an interaction prompt including action guidance such as sliding, dragging, and tapping. Then, based on the user terminal device, the user performs an operation based on the prompt, and the mobile phone terminal detects a touch point and an interaction path. Then, based on an advertisement server, after the user successfully completes an interactive operation (a target interactive operation), the advertisement server receives a request sent by the video server, and presents one or more advertisement elements to the user. Then, the user terminal device detects a matching degree between an interaction path (a current sliding trajectory) of the user and a preset path (a target sliding trajectory), and if the interaction path of the user does not match the preset path, continues to present the interaction guidance (guide information) and dynamically adjusts the guidance based on an operation habit of the user, or if the interaction path of the user accurately matches the preset path, resumes video playback and presents one or more advertisement elements simultaneously. Finally, the terminal device sends interaction behavior data of the user on the advertisement to the advertisement server for analysis, to implement accurate advertisement delivery.

In one embodiment, detection of a user interaction matching degree is mainly for evaluating consistency between the actual operation path of the user and the preset interaction path. First, a user operation is identified. When the user performs interactive operations in a player, such as sliding, dragging, and tapping, a system records and identifies specific trajectories of the operations in real time. Then, trajectory comparison is performed, to compare an actual operation trajectory of the user with the preset interaction path, so as to calculate a matching degree between the actual operation trajectory and the preset interaction path. Next, the matching degree is evaluated according to a particular algorithm. For example, an average difference, a maximum difference, and a variance of differences are used for evaluating. A degree of difference between the actual operation trajectory of the user and the preset path is quantified as the matching degree. Then, threshold-based evaluation is performed, and a matching degree threshold is set. When a matching degree of an operation of the user exceeds the threshold, it is considered that the operation matches the preset path. Otherwise, it is considered that the matching degree is insufficient. In addition, a feedback mechanism may be further set. To be specific, for an operation whose matching degree is insufficient, the system may provide feedback in a plurality of manners, for example, displaying operation guidance again, or dynamically adjusting the interaction path based on the operation habit of the user.

In one embodiment, the interaction guidance may also be adaptively adjusted based on a sliding trajectory of the user. First, sliding data is collected, and a sliding behavior of the user needs to be detected and recorded. This process includes specific information such as a sliding speed, a sliding direction, sliding time, and a sliding amplitude of the user. Then, trajectory analysis is performed to analyze specific data of the sliding trajectory, and the data includes, but is not limited to, locations of sliding start and end points, a sliding distance and sliding time, a sliding speed, and the like. Next, a sliding habit and tendency of the user may be predicted based on the data. Then, an AI technology like machine learning is used to predict a future sliding path of the user based on historical sliding data of the user. A behavior mode of each user may be self-learned and adapted to, to adjust the preset interaction path. Then, the guidance is adjusted, that is, the interaction path and the guidance are adjusted to adapt to the sliding habit of the user based on the foregoing analysis and prediction result. For example, if it is found that the user is good at sliding from left to right, interaction elements may be correspondingly arranged from left to right, so that the user operation is smoother and more natural. Finally, real-time feedback is performed. To be specific, feedback of the user is continuously collected, and an AI model is updated in real time, to continuously improve prediction accuracy of the AI model, and continue to perform adaptive adjustment. In this way, an interaction habit of the user can be identified in real time and adapted to, and an interaction path and guidance that are more consistent with a behavior of the user are provided, thereby improving user experience.

In some embodiments, for a user having more than one preference plot, an interaction path may be designed for plot selecting. For example, at a fork in a plot, the user selects a direction of the plot through a next interactive operation. In addition, a character-centered advertising form may be further designed. For example, a user is allowed to interact when a particular character appears or performs a key action, thereby enhancing a sense of identification and emotional connection of the user with the character.

In this way, first, adding a user interaction segment to a video watching process can greatly increase engagement of the user, so that the user has a sense of active participation while watching, to make entire watching experience more interesting, increase a preference of the user for the video, and also increase stay time of the user on a platform. Second, the user watching the video may interact based on the prompt. In comparison with an interrupted advertisement in related art, attention of the user can be better attracted, and an interaction rate and a conversion rate of the advertisement are improved, so that an advertisement effect is more significant. Third, user interaction data is captured and the data is analyzed to learn a personalized requirement and a preference of the user, so as to push an advertisement that the user may like or need, thereby improving an accurate delivery rate of the advertisement, and improving satisfaction of the user. Fourth, the user interaction data is analyzed in real time, to dynamically adjust the interaction guidance to optimize user experience, thereby greatly improving advertisement acceptance of the user, and improving advertising efficiency. Based on this, the technical solutions of the present disclosure bring higher user stickiness, a better advertising effect, more accurate personalized recommendation, and learning and optimization capabilities, thereby bringing better effects to both advertisers and users.

According to the foregoing embodiments, first, in a process of playing the video at the first playback speed, when the playback adjustment condition of the video is satisfied, a playback speed of the video is switched to the second playback speed less than the first playback speed, and the guide information for guiding to perform the target interactive operation on currently-played video content is displayed. Therefore, based on the guide information, in response to that the target interactive operation is performed, the playback speed of the video is restored to the first playback speed, and the target content is displayed. In this way, the video is played based on the target interactive operation performed by the user on the currently-played video content, and the target content is displayed, thereby not only improving interaction engagement of the user and a sense of participation of the user on the currently-played video content, but also improving diversity of information presentation manners during video playback, and improving human-computer interaction efficiency and utilization of hardware resources of the electronic device.

The following continues to describe an exemplary structure in which an information presentation apparatus 455 provided in embodiments of the present disclosure is implemented as a software module. In some embodiments, as shown in FIG. 2, the software module in the information presentation apparatus 455 stored in the memory 450 may include:
a first display module 4551, configured to display a video played at a first playback speed on a video playback interface;
a second display module 4552, configured to: play the video at a second playback speed less than the first playback speed and display guide information in response to that a playback adjustment condition of the video is satisfied, the guide information being configured for guiding to perform a target interactive operation on the video playback interface; and
a third display module 4553, configured to: play the video at the first playback speed and display target content in response to that the target interactive operation is performed.

In some embodiments, the guide information includes a guide animation and guide text. The second display module 4552 is further configured to: display the guide animation on the video playback interface and display, in an associated area of the guide animation, the guide text corresponding to animation content of the guide animation, the guide animation being configured for presenting an operation manner for performing the target interactive operation.

In some embodiments, the apparatus further includes a fourth display module. The fourth display module is configured to play, through a floating window in a process of displaying of the guide information, a video clip associated with video content of the video in an associated area of the guide information, the video clip being video content of the video that is not played, and being configured for instructing to continue to play the video when the target interactive operation is completed.

In some embodiments, the target interactive operation includes a sliding operation, and the guide information includes a target sliding trajectory and prompt information configured for prompting to perform the sliding operation based on the target sliding trajectory. The third display module 4553 is further configured to: display a current sliding trajectory of the sliding operation in response to that the sliding operation is performed; and play the video at the first playback speed and display the target content when the current sliding trajectory of the sliding operation matches the target sliding trajectory.

In some embodiments, the apparatus further includes a switching module. The switching module is configured to switch the target sliding trajectory to a new target operation trajectory when the current sliding trajectory of the sliding operation does not match the target sliding trajectory.

In some embodiments, the guide information includes an interactive element and prompt information configured for prompting to perform a blowing operation on the interactive element, and the target interactive operation includes the blowing operation on the interactive element. The third display module 4553 is further configured to: display, in response to that the blowing operation on the interactive element is performed, a process in which the interactive element is blown up; and play the video at the first playback speed and display the target content when a height at which the interactive element is blown up reaches a height threshold, or a size at which the interactive element is blown up reaches a size threshold.

In some embodiments, the guide information includes an interactive element and prompt information configured for prompting to perform a shaking operation on a terminal playing the video, and the target interactive operation includes the shaking operation on the terminal. The third display module 4553 is further configured to: display, in response to that the shaking operation on the terminal is performed, a process in which the interactive element moves from a current position to a target position; and play the video at the first playback speed and display the target content when the interactive element moves to the target position.

In some embodiments, the apparatus further includes a determining module. The determining module is configured to: obtain currently-played video content; and determine, if the currently-played video content is key content of the video, or the currently-played video content is associated with the target content, that the playback adjustment condition is satisfied.

In some embodiments, the apparatus further includes a fifth display module. The fifth display module is configured to display an atmosphere element corresponding to the target content, the atmosphere element being in a special effect state and being configured for enhancing a visual effect of the target content.

In some embodiments, a quantity of atmosphere elements may be more than one. The fourth display module is further configured to display, on the video playback interface, a process in which the plurality of atmosphere elements appear from a first end of the playback interface, move to a second end of the playback interface, and disappear from the second end, at least two of the plurality of atmosphere elements having different appearing time or different moving speeds.

In some embodiments, the target content includes the interactive element. The apparatus further includes a jumping module. The jumping module is configured to perform a page jump from the video playback interface to a landing page of the target content in response to a trigger operation on the interactive element.

In some embodiments, the target interactive operation corresponds to a plurality of pieces of operation content, and different operation content corresponds to different target content. The third display module 4553 is further configured to: play the video at the first playback speed and display target content corresponding to the operation content of the target interactive operation, in response to that the target interactive operation is performed.

In some embodiments, the target interactive operation includes the sliding operation, the operation content is the sliding path for the currently-played video content, the guide information includes a plurality of sliding paths and prompt information for the sliding path, and the prompt information is configured for prompting to perform the sliding operation on the video content based on at least one of the plurality of sliding paths. The third display module 4553 is further configured to: play the video at the first playback speed and display target content corresponding to a target sliding path, in response to that a sliding operation for the target sliding path in the plurality of sliding paths is performed.

In some embodiments, the different operation content is further configured for indicating different video content when the video continues to be played. The third display module is further configured to continue to play target video content, the target video content corresponding to the operation content of the target interactive operation.

In some embodiments, the apparatus further includes a sixth display module. The sixth display module is configured to display a close control for the target content in a process of displaying the target content, the close control being configured to cancel display of the target content.

In some embodiments, the apparatus further includes a seventh display module. The seventh display module is configured to: display a display duration for the target content; and cancel display of the target content when the display duration reaches a target display duration.

In some embodiments, the third display module 4553 is further configured to: play the video at the first playback speed and display first target content if a quantity of objects on which the target interactive operation is currently performed online reaches a target quantity, in response to that the target interactive operation is performed; or display second target content if the quantity of objects on which the target interactive operation is currently performed online does not reach the target quantity, the second target content being different from the first target content.

In some embodiments, the second display module 4552 is further configured to: obtain a target object type to which a target object playing the video belongs, different object types corresponding to different interactive operations, and the different interactive operations having different levels of operation difficulty; select the target interactive operation from a plurality of interactive operations based on the target object type; and display the guide information corresponding to the target interactive operation.

In some embodiments, the apparatus further includes an eighth display module. The eighth display module is configured to: display a switch control, the switch control being configured to switch the target content; and switch the target content to new target content in response to a trigger operation on the switch control.

In some embodiments, the apparatus further includes a ninth display module. The ninth display module is configured to: display, when the switch control is displayed, switch prompt information carried in the switch control, the switch prompt information being configured for prompting a reward after the trigger operation is performed; and display a virtual resource, the virtual resource being associated with the new target content and used as the reward for the trigger operation on the switch control.

In some embodiments, the apparatus further includes a tenth display module. The tenth display module is configured to: display at least one interaction control for the target content when the target content is displayed, the interaction control being configured to instruct to perform an interactive operation for the target content, and different interaction controls indicating different interactive operations; and perform, in response to a trigger operation on a target interaction control in the at least one interaction control, the target interactive operation indicated by the target interaction control for the target content.

In some embodiments, the second display module 4552 is further configured to: play, in response to that the playback adjustment condition of the video is satisfied, when an object level of a target object that triggers a playback event of the video does not reach a level threshold, the video at the second playback speed less than the first playback speed; and continue to play the video at the first playback speed when the object level of the target object reaches the level threshold.

In some embodiments, the second display module 4552 is further configured to: obtain a mapping relationship between the object level of the target object and a playback speed of the video, in response to that the playback adjustment condition of the video is satisfied, and when the object level of the target object that triggers the playback event of the video does not reach the level threshold, ; and determine the second playback speed based on the object level of the target object and the mapping relationship, and play the video at the second playback speed.

An embodiment of the present disclosure provides a computer program product. The computer program product includes computer-executable instructions. The computer-executable instructions are stored in a computer-readable storage medium. A processor of an electronic device reads the computer-executable instructions from the computer-readable storage medium. The processor executes the computer-executable instructions to cause the electronic device to perform the information presentation method in embodiments of the present disclosure.

An embodiment of the present disclosure provides a computer-readable storage medium having computer-executable instructions stored therein. The computer-executable instructions, when being executed by a processor, cause the processor to perform the information presentation method provided in embodiments of the present disclosure, for example, the information presentation method shown in FIG. 3.

In some embodiments, the computer-readable storage medium may be a memory like a read-only memory (ROM), a random access memory (RAM), an erasable programmable read-only memory (EPROM), an electrically erasable programmable read-only memory (EEPROM), a flash memory, a magnetic surface memory, an optical disk, or a CD-ROM, and may alternatively be various devices including one of the foregoing memories or any combination thereof.

In some embodiments, the executable instructions may be written in the form of program, software, software module, script, or code in any form of programming language (including compilation or interpretation language, or declarative or procedural language), and the executable instructions may be deployed in any form, including being deployed as an independent program or being deployed as a module, component, subroutine, or another unit suitable for use in a computing environment.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

As an example, the executable instructions may be but are not necessarily corresponding to a file in a file system, and may be stored in a part of a file that stores another program or data, for example, stored in one or more scripts in a Hypertext Markup Language (HTML) document, stored in a single file dedicated to a program under discussion, or stored in a plurality of synchronous files (for example, a file that stores one or more modules, subprograms, or code parts).

As an example, the executable instructions may be deployed to be executed on one electronic device, or on a plurality of electronic devices located in one location, or on a plurality of electronic devices distributed in a plurality of locations and interconnected through a communication network.

In conclusion, embodiments of the present disclosure have the following beneficial effects.
(1) The video is played based on the target interactive operation performed by the user on the currently-played video content, and the target content is displayed, thereby not only improving interaction engagement of the user and a sense of participation of the user on the currently-played video content, but also improving diversity of information presentation manners during video playback, and improving human-computer interaction efficiency and utilization of hardware resources of the electronic device.
(2) The user is attracted to complete the target interactive operation based on the video clip, to continue to play the video, thereby improving a possibility that the user performs the target interactive operation, and improving human-computer interaction rate.
(3) The video content that continues to be played and the target content are displayed together. Based on the close control, the target content may be closed when the user wants to watch only the video, thereby improving user experience.
(4) Display of the target content may be canceled when the display duration reaches the target display duration, and the video content may continue to be played. In this way, a possibility that the user completely watches the target content is increased, so that an exposure rate of the target content is ensured, to increase a conversion rate of the target content.
(5) Based on the interactive operation performed for the target content, the target content may be commented, or the target content may be shared to another platform, thereby further strengthening interaction of the user, and improving reach and popularity of the target content.
(6) Through collecting and analyzing of the interaction path and the feedback of the user, according to the technical solution of the present disclosure, accurate division and targeted delivery of advertisements can be implemented, to effectively improve acceptance of the advertisements, thereby greatly improving the advertising effect.
(7) First, adding a user interaction segment to a video watching process can greatly increase engagement of the user, so that the user has a sense of active participation while watching, to make entire watching experience more interesting, increase a preference of the user for the video, and also increase stay time of the user on a platform. Second, the user watching the video may interact based on the prompt. In comparison with an interrupted advertisement in related art, attention of the user can be better attracted, and an interaction rate and a conversion rate of the advertisement are improved, so that an advertisement effect is more significant. Third, user interaction data is captured and the data is analyzed to learn a personalized requirement and a preference of the user, so as to push an advertisement that the user may like or need, thereby improving an accurate delivery rate of the advertisement, and improving satisfaction of the user. Fourth, the user interaction data is analyzed in real time, to dynamically adjust the interaction guidance to optimize user experience, thereby greatly improving advertisement acceptance of the user, and improving advertising efficiency. Based on this, the technical solutions of the present disclosure bring higher user stickiness, a better advertising effect, more accurate personalized recommendation, and learning and optimization capabilities, thereby bringing better effects to both advertisers and users.

In embodiments of the present disclosure, data related to user operations, user historical behavior data, object information, and the like is involved. When embodiments of the present disclosure are applied to specific products or technologies, corresponding permission or consent needs to be obtained, and collection, use, and processing of related data need to comply with related laws, regulations, and standards of related countries and regions.

The foregoing descriptions are merely examples of embodiments of the present disclosure and are not intended to limit the protection scope of the present disclosure. Any modification, equivalent replacement, or improvement made within the spirit and scope of the present disclosure fall within the protection scope of the present disclosure.

What is claimed is:

1. An information presentation method, performed by an electronic device, the method comprising:
displaying a video played at a first playback speed on a video playback interface;
playing the video at a second playback speed less than the first playback speed and displaying guide information in response to that a playback adjustment condition of the video is satisfied, the guide information providing guidance for performing a target interactive operation on the video playback interface; and
playing the video at the first playback speed and displaying target content in response to that the target interactive operation is performed.

2. The method according to claim 1, wherein the guide information comprises a guide animation and guide text, and the displaying guide information comprises:
displaying the guide animation on the video playback interface and displaying, in an associated area of the guide animation, the guide text corresponding to animation content of the guide animation,
the guide animation presenting an operation manner for performing the target interactive operation.

3. The method according to claim 1, further comprising:
playing, through a floating window in a process of displaying the guide information, a video clip associated with video content of the video in an associated area of the guide information,
the video clip being video content of the video that is not played, and being configured to indicate continuing to play the video when the target interactive operation is completed.

4. The method according to claim 1, wherein the target interactive operation comprises a sliding operation, and the guide information comprises a target sliding trajectory and prompt information about performing the sliding operation based on the target sliding trajectory; and
the playing the video at the first playback speed and displaying target content in response to that the target interactive operation is performed comprises:
displaying a current sliding trajectory of the sliding operation in response to that the sliding operation is performed;
playing the video at the first playback speed and displaying the target content in response to the current sliding trajectory of the sliding operation matching the target sliding trajectory; and
switching the target sliding trajectory to a second target operation trajectory in response to the current sliding trajectory of the sliding operation not matching the target sliding trajectory.

5. The method according to claim 1, wherein the guide information comprises an interactive element and prompt information about performing a blowing operation on the interactive element, and the target interactive operation comprises the blowing operation on the interactive element; and
the playing the video at the first playback speed and displaying target content in response to that the target interactive operation is performed comprises:
displaying, in response to that the blowing operation on the interactive element is performed, a process in which the interactive element is blown up; and
playing the video at the first playback speed and displaying the target content in response to a height at which the interactive element is blown up reaching a height threshold, or a size at which the interactive element is blown up reaching a size threshold.

6. The method according to claim 1, wherein the guide information comprises an interactive element and prompt information about performing a shaking operation on a terminal playing the video, and the target interactive operation comprises the shaking operation on the terminal; and
the playing the video at the first playback speed and displaying target content in response to that the target interactive operation is performed comprises:
displaying, in response to that the shaking operation on the terminal is performed, a process in which the interactive element moves from a current position to a target position; and
playing the video at the first playback speed and displaying the target content when the interactive element moves to the target position.

7. The method according to claim 1, further comprising:
obtaining currently-played video content; and
determining, in response to the currently-played video content being key content of the video, or the currently-played video content being associated with the target content, that the playback adjustment condition is satisfied.

8. The method according to claim 1, further comprising:
displaying an atmosphere element corresponding to the target content,
the atmosphere element being in a special effect state and being configured to enhance a visual effect of the target content.

9. The method according to claim 8, wherein a quantity of atmosphere elements is more than one, and the displaying an atmosphere element corresponding to the target content comprises:
displaying, on the video playback interface, a process in which the plurality of atmosphere elements appear from a first end of the playback interface, move to a second end of the playback interface, and disappear from the second end,
at least two of atmosphere elements having different appearing time or different moving speeds.

10. The method according to claim 1, wherein the target content comprises the interactive element, and the method further comprises:
performing a page jump from the video playback interface to a landing page of the target content in response to a trigger operation on the interactive element.

11. The method according to claim 1, wherein the target interactive operation corresponds to a plurality of pieces of operation content, and different operation content corresponds to different target content; and
the playing the video at the first playback speed and displaying target content in response to that the target interactive operation is performed comprises:
playing the video at the first playback speed and displaying target content corresponding to the operation content of the target interactive operation, in response to that the target interactive operation is performed.

12. The method according to claim 11, wherein the target interactive operation comprises a sliding operation, the operation content is a sliding path for currently-played video content, the guide information comprises a plurality of sliding paths and prompt information for the sliding path, and the prompt information is about performing the sliding operation on the video content based on at least one of the plurality of sliding paths; and
the playing the video at the first playback speed and displaying target content corresponding to the operation content of the target interactive operation, in response to that the target interactive operation is performed, comprises:
playing the video at the first playback speed and displaying target content corresponding to a target sliding path, in response to that a sliding operation for the target sliding path in the plurality of sliding paths is performed.

13. The method according to claim 1, wherein the playing the video at the first playback speed and displaying target content in response to that the target interactive operation is performed comprises:
playing the video at the first playback speed and displaying first target content in response to a quantity of objects on which the target interactive operation is currently performed online reaching a target quantity, and in response to that the target interactive operation is performed; or
displaying second target content in response to the quantity of objects on which the target interactive operation is currently performed online not reaching the target quantity, the second target content being different from the first target content.

14. The method according to claim 1, wherein the displaying guide information comprises:
obtaining a target object type to which a target object playing the video belongs, different object types corresponding to different interactive operations, and the different interactive operations having different levels of operation difficulty;
selecting the target interactive operation from a plurality of interactive operations based on the target object type; and
displaying the guide information corresponding to the target interactive operation.

15. The method according to claim 1, further comprising:
displaying a switch control, the switch control being configured to switch the target content;
displaying, when the switch control is displayed, switch prompt information carried in the switch control, the switch prompt information indicating a reward after the trigger operation is performed;
switching the target content to second target content in response to a trigger operation on the switch control; and
displaying a virtual resource, the virtual resource being associated with the second target content and used as the reward for the trigger operation on the switch control.

16. The method according to claim 1, further comprising:
displaying at least one interaction control for the target content when the target content is displayed,
the interaction control being configured to instruct to perform an interactive operation for the target content, and different interaction controls indicating different interactive operations; and
performing, in response to a trigger operation on a target interaction control in the at least one interaction control, the target interactive operation indicated by the target interaction control for the target content.

17. The method according to claim 1, wherein the playing the video at a second playback speed less than the first playback speed in response to that a playback adjustment condition of the video is satisfied comprises:
playing the video at the second playback speed less than the first playback speed in response to that the playback adjustment condition of the video is satisfied and when an object level of a target object that triggers a playback event of the video does not reach a level threshold; and
the method further comprises:
continuing to play the video at the first playback speed when the object level of the target object reaches the level threshold.

18. The method according to claim 17, wherein the playing the video at the second playback speed less than the first playback speed in response to that the playback adjustment condition of the video is satisfied, when an object level of a target object that triggers a playback event of the video does not reach a level threshold comprises:
obtaining a mapping relationship between the object level of the target object and a playback speed of the video in response to that the playback adjustment condition of the video is satisfied and when the object level of the target object that triggers the playback event of the video does not reach the level threshold; and
determining the second playback speed based on the object level of the target object and the mapping relationship, and playing the video at the second playback speed.

19. An electronic device, comprising:
a memory, configured to store computer-executable instructions or a computer program; and
a processor, configured, when executing the computer-executable instructions or the computer program stored in the memory, to implement:
displaying a video played at a first playback speed on a video playback interface;
playing the video at a second playback speed less than the first playback speed and displaying guide information in response to that a playback adjustment condition of the video is satisfied, the guide information providing guidance for performing a target interactive operation on the video playback interface; and
playing the video at the first playback speed and displaying target content in response to that the target interactive operation is performed.

20. A non-transitory computer-readable storage medium, having computer-executable instructions or a computer program stored therein, the computer-executable instructions or the computer program, when executed by a processor, causing the processor to implement:
displaying a video played at a first playback speed on a video playback interface;
playing the video at a second playback speed less than the first playback speed and displaying guide information in response to that a playback adjustment condition of the video is satisfied, the guide information providing guidance for performing a target interactive operation on the video playback interface; and
playing the video at the first playback speed and displaying target content in response to that the target interactive operation is performed.
